(19) United States
(12) Patent Application Publication
(10) Pub. No.: US 2026/0140937 A1
(43) Pub. Date: May 21, 2026

(54) GENERATING EMBEDDINGS IN AN OBJECT STORAGE SYSTEM

(71) Applicant: HEWLETT PACKARD ENTERPRISE DEVELOPMENT LP, Spring, TX (US)

(72) Inventors: Annmary Justine Koomthanam, Fort Collins, CO (US); Srikant Varadan, Fremont, CA (US); Suparna Bhattacharya, Bangalore (IN); Rajesh Sundaram, Mountain View, CA (US); Martin Foltin, Fort Collins, CO (US); Louis Beauvais, Hopkinton, MA (US); Paolo Faraboschi, Milpitas, CA (US); Alex Veprinsky, San Ramon, CA (US)

(21) Appl. No.: 19/096,258

(22) Filed: Mar. 31, 2025

(30) Foreign Application Priority Data
Nov. 19, 2024 (IN) 202441089638

(51) Int. Cl. G06F 16/23

(52) U.S. Cl. CPC G06F 16/2358; G06F 16/235

(57) ABSTRACT

Systems and methods are provided for automatically generating an embedding that is linked to a newly created data object by its primary key. For example, in response to entering a data object into an object data structure of the object storage system, the system may automatically generate an embedding comprising a primary key of the data object that links the embedding with the data object. In response to receiving an update of the data object, the system may automatically identify the primary key of the data object and synchronize, using a notification service of the object storage system, the embedding with the update of the data object.

### CROSS REFERENCE TO RELATED APPLICATIONS

This application claims the benefit of and priority to India Provisional Patent Application No. 202441089638, filed on Nov. 19, 2024, the contents of which are incorporated herein by reference in their entirety.

### BACKGROUND

Retrieval-Augmented Generation (RAG) is a feature of artificial intelligence (AI) technology that references an authoritative knowledge base outside of its training data sources before generating a response. That is, the generated response can be supplemented with additional information that was not a part of/not used to train an AI model. Thus, the ability of an AI model to generate an output for various tasks (where the AI model is trained on large volumes of data and uses billions of parameters) can be extended by RAG to encompass specific domains without a need to retrain the AI model.

In some examples, the RAG agent may access distributed computing systems that publish data in these various domains. The RAG agent can identify and assess which information is the most relevant to return to the AI model to generate the response. The ability to access several sources of information may help the RAG agent determine which of the distributed computing systems can provide data that can generate the best response.

### BRIEF DESCRIPTION OF THE DRAWINGS

The present disclosure, in accordance with one or more various examples, is described in detail with reference to the following figures. The figures are provided for purposes of illustration only and merely depict typical, non-limiting aspects of such examples.

FIG. 1 is an example of an object storage system with access to local and remote data stores and an AI model, in accordance with examples discussed herein.

FIG. 2 is an example embedding record, in accordance with some examples discussed herein.

FIG. 3 illustrates a data structure interaction between the data service managing the data object and the embedding service managing the embedding, in accordance with examples discussed herein.

FIG. 4 illustrates a process for maintaining data accuracy between a data object record and an embedding record, in accordance with examples discussed herein.

FIG. 5 ILLUSTRATES A PROCESS FOR GENERATING EMBEDDINGS, IN ACCORDANCE with examples discussed herein.

FIG. 6 is a process for generating an embedding in an object storage system, in accordance with examples discussed herein.

FIG. 7 is an example computing component that may be used to generate an embedding in accordance with examples discussed herein.

FIG. 8 is a process for synchronizing an embedding record with a data object record, in accordance with examples discussed herein.

FIG. 9 is an example computing component that may be used to synchronize an embedding record with a data object record in accordance with examples discussed herein.

FIG. 10 is a process for accessing an embedding record, in accordance with examples discussed herein.

FIG. 11 is an example computing component that may be used to access an embedding record in accordance with examples discussed herein.

FIG. 12 is a process for generating/synchronizing a data object record with an embedding record, in accordance with examples discussed herein.

FIG. 13 is a computing component that may be used to implement examples of the disclosed technology.

The figures are not exhaustive and do not limit the present disclosure to the precise form disclosed.

### DETAILED DESCRIPTION

As noted above, RAG can help an AI model generate better/more relevant responses. RAG can further help or enhance AI models by expediting information retrieval using embeddings that are accessible by an AI model. For example, when the AI model utilizes a RAG agent, the RAG agent may use these embeddings to assess the relevancy of the information prior to retrieving the information to generate the response. Embeddings can represent the information in a standardized, numerical format that the RAG agent can quickly and efficiently process, especially when the information is originally available in an unstructured data format (e.g., text, images, or audio) at the distributed computing systems.

“Embeddings” can represent the unstructured data in a vector format as a vector of numbers in a defined dimension representing unique fingerprints/values for a piece of data. In some examples, the vector format of the embedding can reduce the data dimensionality and capture the most important features of the unstructured data. The embedding may be stored as an embedding record in an embedding vector store. The points identified in the vector format may be semantically meaningful to the AI model or other machine learning (ML) algorithms, including large language models (LLMs). These AI models may efficiently operate on the embeddings to quickly retrieve the relevant unstructured data in its translated form.

A traditional embedding generation pipeline may retrieve the unstructured data, provide the unstructured data to an embedding process to extract the relevant features, and then store the results as an embedding record in an embedding vector store. However, due to inefficient organization of the unstructured data, whether in its raw, pre-processed state or after the data has been cleaned, additional information may not be captured in the embedding. When the RAG agent attempts to access the additional information, this can add inefficiency to the process of generating a response.

Also, in some traditional systems, the RAG agent may merely access the embeddings in the distributed computing system, and thus may not be aware of the lifecycle of the data (e.g., where lifecycle of a data object corresponding with the data may include the creation, modification, or deletion of the data object). By being unaware of the lifecycle of the data object, the object permissions may be out-of-date and current policies related to data access may be violated, causing a potential latency/inaccuracy between generating the data objects and the availability of the embeddings for the AI model to use the data in generating a relevant response.

Examples of the disclosed technology comprise an object storage system that automatically generates an embedding linked to a newly created data object. The embedding may be stored in an embedding vector store as an embedding record. The embedding record may comprise a primary key that identifies the embedding record (e.g., a second primary key corresponding to the embedding), the object ID that identifies the data object, and an N-dimensional embedding vector that identifies the embedding created from the embedding process of the unstructured data. The data object may be stored in an object data store as a data object record with an object identifier (ID) to uniquely identify the data object. The object ID of the data object can also be stored with the newly created embedding record to link the embedding record with the data object record that was generated in response to the creation of the data object record. Other information may be included with the data object record or embedding record without diverting from the essence of the disclosure (e.g., chunk ID identifying an embedding of a chunk of the data object, version ID of the chunk of the data object, etc.).

The primary key of the data object, which may be stored as the object ID of the embedding record, may be a Universally Unique Identifier (UUID) or other identifier that uniquely identifies one or more rows corresponding to the data object in the data object store. Various formats of the primary key may be implemented without diverting from the essence of the disclosure (e.g., 128 bit). When the object ID of the data object is stored in the embedding vector store, the object ID can link the embedding record with the data object record in both the data object store and the embedding vector store. In some examples, the primary key of the embedding record may also be stored with the data object in the data object store to provide a plurality of connections/references between the data object and embedding.

In some examples, a data object record can be associated with a plurality of embedding records (and corresponding embeddings). These embedding records may be generated with a primary key of the embedding record and the object ID of the corresponding data object. In some examples, the object ID may also be stored as a UUID (e.g., object ID UUID) or other identifier that uniquely identifies one or more rows corresponding to the data object in the data object store. In this sense, the data object may be uniquely identified using the object ID, yet the primary key of the embedding record may not be used to uniquely identify the data object (since a plurality of embedding records may be generated from/linked to the data object).

Various operations can be initiated using the linked data records. For example, the object storage system that locally stores the data object record and the embedding record may also comprise a management service, a notification service, a data service, and an embedding service. The management service may identify a policy or rule that is applied on the data object record by the data service (e.g., create, update, delete, etc.). The notification service can notify the embedding service to apply the same policies to the embedding record. In this example and in response to receiving an instruction to update the data object record, the system can utilize these and other services to automatically identify the primary key of the data object and synchronize the embedding record associated with the data object. The link between the data object and corresponding embedding(s) may be the primary key of the data object and the object ID in the embedding vector store. Using this linking, the system can automatically create and update embeddings in line with the data object's creation, update, deletion, or other data object-related actions.

Additionally, using the link between the embedding record and the data object record, retrieval operations performed by an AI model (e.g., RAG agent, LLM, or other information-based search process) can be expedited, which in turn, can further expedite generation of the response. The AI model may be able to generate a quicker assessment of the relevance of the embedding representing the unstructured data to determine whether the unstructured data is relevant in generating the response. For example, a similarity search can be conducted by a RAG agent, which can access the embedding vectors that are stored in an embedding vector store, and compare them with an embedded version and version ID of an unstructured query or user prompt. The similarity search can entail initiating an embedding process of the user prompt and retrieving embedding vectors that are most similar to the embedded user prompt. In some examples, user input can be run through the embedding vector store, where a similarity search can be performed to retrieve data and allow the LLM to generate a response to the user prompt.

Technical improvements are realized throughout the disclosure. For example, using this data structure, the RAG agent can efficiently access relevant data with fewer input/output (I/O) operations between the object system and external systems. This can free up additional bandwidth for other messages to be transmitted throughout the network. In some examples, the system can generate data embeddings within an object storage system, which moves data retrieval and ingestion operations (that are often resource-intensive) to a local data store and facilitates the development of generative AI applications on unstructured data (such as text or images).

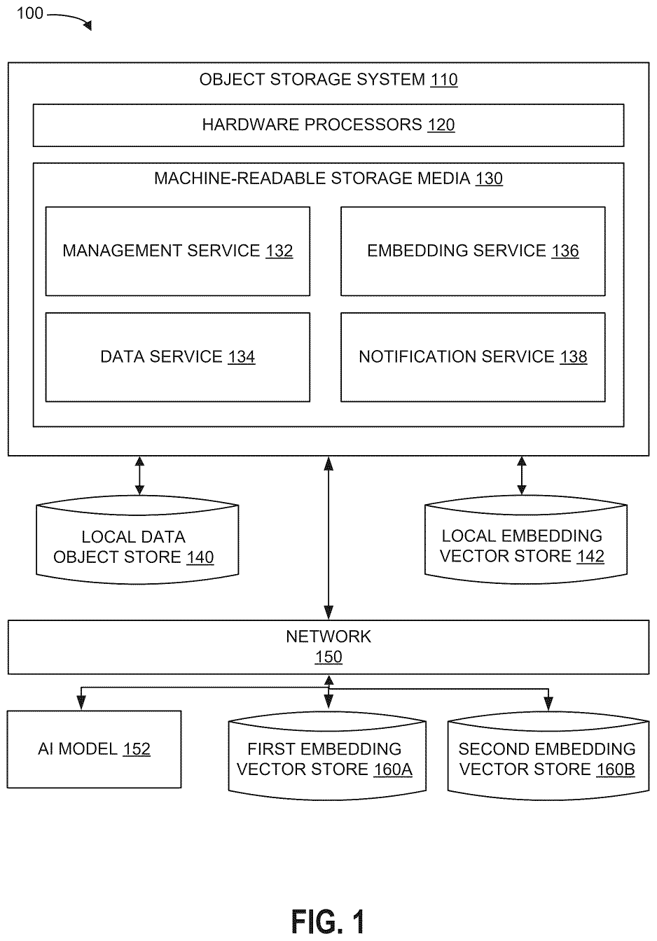

FIG. 1 is an example of a networked storage system 100. The networked storage system 100 of FIG. 1 may include an object storage system 110 with access to local and remote data stores 140, 142, 160 and an AI model 152, as will be described later, in accordance with examples discussed herein. In this example, object storage system 110 may be a server computer, a controller, or any other similar computing component capable of processing and transmitting data. Object storage system 110 may also comprise hardware processor 120 and machine-readable storage medium 130.

Hardware processor 120 may be one or more central processing units (CPUs), semiconductor-based microprocessors, and/or other hardware devices suitable for retrieval and execution of instructions stored in machine-readable storage medium 130. Hardware processor 120 may fetch, decode, and execute instructions to control processes or operations for generating embeddings. As an alternative or in addition to retrieving and executing instructions, hardware processor 120 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 130, may be any electronic, magnetic, optical, or other physical storage device that contains or stores executable instructions. Thus, machine-readable storage medium 130 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 130 may be a non-transitory storage medium, where the term “non-transitory” does not encompass transitory propagating signals, comprising a set of services for executing the machine-readable instructions, including management service 132, data service 134, embedding service 136, and notification service 138. Program instructions of these services, when executed by the hardware processor 120, cause the hardware processor 120 to execute the respective functionalities of the services. Further, object storage system 110 may also access, process, and store data in various local data stores, including local data object store 140 and local embedding vector store 142, and also access remote data stores via network 150, including a plurality of embedding vector stores 160 (illustrated as first embedding vector store 160A and embedding vector store 160B). These data stores may correspond to an embedding vector store, database, or other data storage format.

Data service 134 is configured to create a data object. For example, unstructured data may be received by data service 134, and data service 134 can generate the data object based on the unstructured data. The data object may be stored as a data object record in local data object store 140 with a primary key associated with the data object that is also stored in local data object store 140.

Embedding service 136 is configured to create an embedding associated with the data object. The embedding can represent the unstructured data as a vector of numbers in a defined dimension representing unique fingerprints/values for the data object. The embedding may be stored as an embedding record in local embedding vector store 142.

In some examples, the individual data object record and the individual embedding record may be stored as groups of data. For example, in response to data service 134 creating the data object, management service 132 is configured to create a bucket of data objects. The objects of the same bucket may be stored in local data object store 140. When a bucket is created in local data object store 140 by management service 132, embedding service 136 is configured to create a corresponding embedding record in local embedding vector store 142. In some examples, a collection of embeddings may be created in local embedding vector store 142 to store a plurality of embeddings of the data objects associated with the bucket of data objects.

Management service 132 is also configured to store the mapping of the bucket of data objects to the collection of embeddings. In some examples, any action taken on the bucket may also be applied to the collection in local embedding vector store 142. The collection may inherit the bucket's user access controls.

Management service 132 is also configured to apply operations executed on the bucket in local data object store 140 to the corresponding collection in local embedding vector store 142. For example, management service 132 may assign the same retention policy and backup policy on the bucket in local data object store 140 and the collection in local embedding vector store 142 when the bucket of data objects is created. Whenever a bucket is backed up, the corresponding collection may also be backed up. When a bucket is deleted, management service 132 may also delete the entire collection.

Management service 132 is configured to oversee, monitor, or otherwise manage an object life cycle on the corresponding embedding stored in local embedding vector store 142. The object life cycle can include, for example, the creation, update, and deletion of the data object and corresponding embedding(s). Various other features may be included in the object life cycle as well, including data retention, back up, and access policies.

Data service 134 is also configured to notify embedding service 136 through notification service 138 (e.g., operated by an event notification system) regarding life cycle events of the data object. For example, the notification may comprise information about events/actions regarding the data object or its life cycle.

Notification service 138 is configured to transmit the notifications between management service 132, data service 134, and embedding service 136 using various data transmission protocols. For example, in response to creating/generating the data object, data service 134 is configured to notify embedding service 136 through notification service 138 of the creation of the new data object. The notification may include the primary key of the data object, which may be stored as the object ID in the new embedding record. In response to updating the data object record or deleting the data object record, data service 134 is also configured to notify embedding service 136 through notification service 138 along with the object ID/primary key of the data object.

In some examples, when the data object is created, the embedding record may not be known to data service 134. Data service 134 may notify embedding service 136 of the new data object by sending the primary key of the new data object in a notification. In response, embedding service 136 can generate the embedding associated with the data object and return an identifier for the new embedding. The identifier may correspond to an embedding UUID or primary key of the embedding record.

In some examples, embedding service 136 is also configured to create chunks of data. For example, chunks of data may be generated in response to receiving the notification of a newly created data object. The data may correspond to chunks of a data object and an embedding can also be created for the chunks. In some examples, embedding service 136 is configured to generate an embedding UUID for the embedding(s) corresponding with the chunk and insert the embedding record into local embedding vector store 142. The embedding record may comprise the embedding UUID, object ID for the corresponding data object, the embedding vector, and any other information associated with the embedding (e.g., object ID, chunk ID, and version ID).

Embedding service 136 is also configured to transmit the primary key of a newly created embedding record to data service 134. In some examples, data service 134 may store the primary key of the embedding record as metadata of the associated data object in local data object store 140. This can help ensure that the embedding record (and corresponding embedding vector) can be identified through the data object, and vice versa.

In response to receiving the notification of an updated data object from notification service 138, embedding service 136 is configured to automatically identify the primary key of the data object and synchronize the embedding when the data object is updated. The synchronization may help maintain the continuity or relationship between the embedding and the data object as changes to the data object occur. For example, embedding service 136 is configured to generate a new embedding record for the new version of the data object. When the data object is stored as a plurality of data chunks, new embeddings may be generated by embedding service 136 for each of the data chunks. The embedding(s) for the data chunk may be inserted into local embedding vector store 142 along with the new primary keys of the data chunks of the data object. The new primary keys of the embeddings may be transmitted by embedding service 136 back to data service 134 to store with the new version of the data object in local data object store 140. This may allow object storage system 110 to create a one-to-one mapping between versions of the data object and its embeddings, which ensures that even if a data object is restored to its old version, the corresponding embedding can be restored without additional processing and overhead.

In some examples, embedding service 136 may update a plurality of embedding records that link to the data object record. These embedding records may automatically inherit the policies associated with the data object record and share the same policies across all of the embedding records in the collection. In some examples, the collection may correspond to a unique policy that is shared by the embeddings in the collection, but not shared with the linked data object.

Object storage system 110 may also coordinate communications for a deletion of a data object. For example, a data object or unstructured data associated with the data object may be deleted (e.g., by a user) and notification service 138 may transmit a communication to data service 134 to delete the corresponding data object record. In response to receiving the notification of deleted data object from notification service 138, embedding service 136 may also be configured to delete the corresponding embedding records based on a comparison between the deleted primary keys for the deleted data object matching the object ID stored in the embedding records.

In other examples, the deletion of the data object may be based on a retention policy. For example, when the retention policy on an object expires, management service 132 may notify data service 134 and data service 134 may delete the data object in local data object store 140 in response to the notification. On object deletion, embedding service 136 may be notified of the deletion with the corresponding UUIDs and embedding service 136 may delete the embedding from local embedding vector store 142.

Local data object store 140 and local embedding vector store 142 may be accessible (e.g., exposed) to users through a set of application programming interfaces (APIs) in embedding service 136. In addition to the automated operations within the system, only authorized users may be permitted to issue operations against embeddings in local embedding vector store 142.

In some examples, the user access policy of the bucket stored in local data object store 140 may be inherited by the collection of embeddings in local embedding vector store 142. In this way, the embedding may be stored in the collection of embeddings, and the collection may automatically inherit policies from the data object. Inheriting user access policies may comprise, for example, automatically setting access permissions of the collection of embeddings to match the access permissions of the bucket of data objects. The policies that are inherited may be the parent level policies that are assigned to the group or organizational hierarchy that the user belongs to, rather than explicitly granting access to each individual collection of embeddings.

Object storage system 110 may use a common authorization and authentication mechanism across data service 134 and embedding service 136. For example, embedding service 136 may be configured to transmit an authentication request to an authentication server. In response to the authentication server determining that the request is valid, the request may be serviced (e.g., to create a data object or embedding). Embedding service 136 may also identify the user permissions or rules associated with the data object to identify relevant authorization policies. The creation, update, or deletion of the data object or embedding may be permitted upon confirmation that the action is authorized under the set policy.

The use of local and other embedding vector stores may vary. In some examples, the availability of local data stores can help reduce the processing time (e.g., for AI model 152 to generate an inference based on a new embedding of the unstructured data). The system can also tune availability of local embedding vector stores that are under control of object storage system 110. For example, object storage system 110 can increase the throughput permissible to access the local data stores and optimize input/output (I/O) traffic. In some examples, object storage system 110 may automatically rebuild an embedding vector store (e.g., as a local copy of the embedding vector store) for object updates and deletions. In some examples, the process of maintaining references to objects that are stored in local data stores can help prevent duplicated data chunks in the vector database of a traditional RAG system.

In some examples, local data object store 140 may comprise data objects associated with unstructured or structured data. A data object can encapsulate the unstructured or structured data and allow operations to be performed on the data. The data object record may correspond to a record or a row in local data object store 140, where the columns represent the attributes of the data object. The data objects stored in local data object store 140 may correspond to at least one embedding that is stored in local embedding vector store 142.

Various processes may help synchronize and link the data objects with embeddings. For example, the object version in local data object store 140 and embedding version in local embedding vector store 142 may be automatically synchronized. Every object version may have an associated embedding version. In some examples, when an object is updated to its latest version in local data object store 140, new embeddings may be automatically created and stored in local embedding vector store 142 for the associated object. In some examples, the embeddings in local embedding vector store 142 are automatically deleted when the data object is deleted in local data object store 140. In some examples, the retention policy, backup policy, and user access permission on the object is automatically applied to its embeddings.

In some examples, a set of data objects are stored as a bucket of data objects in local data object store 140. The set of processes (e.g., bulk operations) executed on the set of objects may be automatically applied to the corresponding group of embeddings in local embedding vector store 142.

AI model 152 is configured to receive a query/prompt, determine a embedding that is relevant to the query/prompt, generate a response to the query/prompt (using the trained ML model associated with the RAG process), and provide the response to an interface. The embedding may be relevant to the query/prompt based on a similarity value between the embedding and the query/prompt.

For example, in RAG, an agent software component is used to access and retrieve the embedding, and the embedding is used to generate a response to a search query or user prompt (used interchangeably). The agent may identify the embedding that is relevant to the query/prompt and respond to the query/prompt with a response that is generated based on the embedding. When multiple responses are generated, the responses can be ranked and the best response can be provided back to the user.

In some examples, AI model 152 may access embeddings to generate the response to the query/prompt that are stored in various locations, including first embedding vector store 160A, second embedding vector store 160B, or local embedding vector store 142. Any of these embeddings may be accessed via network 150.

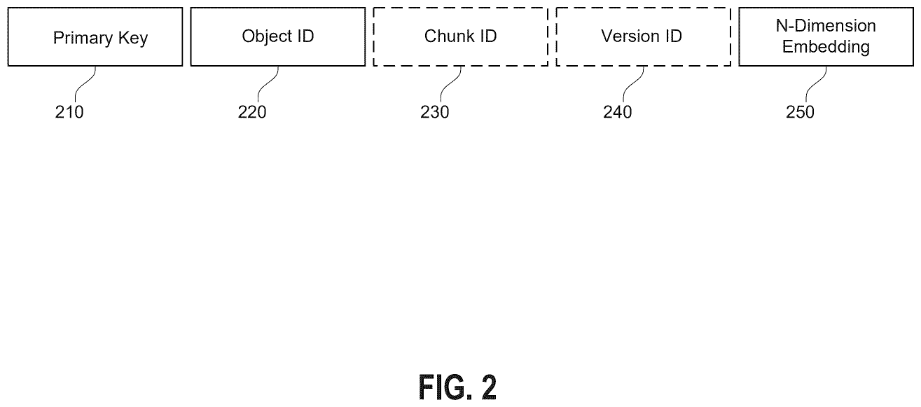

FIG. 2 is an example embedding record, in accordance with some examples discussed herein. The embedding record may be stored in an embedding vector store and may comprise primary key 210, object ID 220, N-dimensional embedding vector 250, as well as optional information, including chunk ID 230 and version ID 240.

Primary key 210 may identify the embedding record. The primary key may correspond to a unique identifier assigned to the record in the embedding vector store. The primary key can be uniquely identified and accessed, and may help prevent duplicate embedding entries.

Object ID 220 may identify the data object. Object ID 220 may reference the primary key of the data object stored in the data object store. In some examples, a plurality of instances of the same object ID may be stored in the embedding vector store (e.g., when a plurality of embeddings are associated with the same data object).

Chunk ID 230 may identify an embedding of a chunk of the data object. For example, the data object may be separated into a plurality of segments that make up a larger data structure or object.

Version ID 240 may identify a version/instance of an embedding for a particular data object or chunk. The version ID may be iteratively incremented (e.g., from zero) as new embeddings are created in the embedding record for the data object.

N-dimension embedding 250 may identify the embedding created from the embedding process of the unstructured data. The embedding may be stored in a vector space with n-dimensions that represent the unstructured data (e.g., text, image, etc.). The vector may encode features of the unstructured data, where a dimension may represent a specific characteristic or feature, and also preserve relevant relationships and semantic information within the vector space.

In some examples, the embedding record may be stored as a fixed data schema. Various lengths may be implemented without diverting from the essence of the disclosure. For example, primary key 210 may comprise a 128-bit UUID representing the primary key of the embedding, object ID 220 may comprise a 128-bit UUID representing the object identifier of the data object, chunk ID 230 may comprise a 32-bit value representing the chunk identifier of a chunk of the data object, version ID 240 may comprise a 8-bit value representing the version ID of the embedding or data object, and N-dimension embedding 250 may comprise an n-dimensional embedding vector field. When the collection of embeddings is implemented in an embedding vector store, the fixed data schema may be implemented for the collection as well.

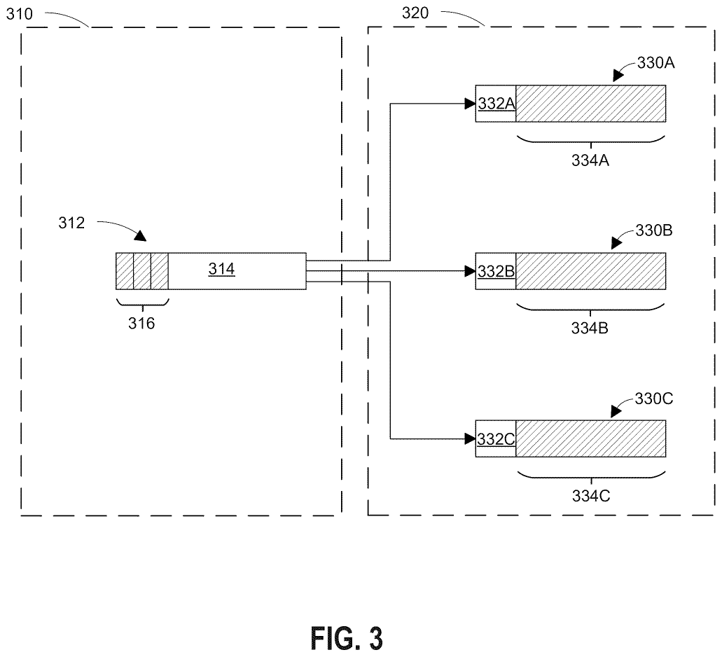

FIG. 3 illustrates a data structure interaction between the data service managing the data object and the embedding service managing the embedding, in accordance with examples discussed herein. In this example, data service 310 may generate data object 312 that comprises primary key 314 and embedding service 320 may generate one or more embeddings (e.g., embeddings 330A, 330B, 330C, hereinafter collectively referred to as embeddings 330A-330C) that comprise the primary key of the data object stored as an object ID (e.g., object IDs 332A, 332B, 332C, hereinafter collectively referred to as object IDs 332A-332C). Data object 312 may comprise primary key 314 and other data 316, including structured or unstructured data that is identified by the primary key (e.g., text, images, audio, or other data).

A plurality of embeddings 330A-330C may be generated by embedding service 320 in association with data object 312. The generated embeddings 330A-330C may comprise object IDs 332A-332C, respectively, that identify the associated data object. In this example, since the embeddings 330 may be generated in association with the same data object 312, the embedding may comprise the same object ID 332, illustrated as object ID 332A, second object ID 332B, and third object ID 332C. In this context, the primary key 314 of data object 312 can also be used as object ID 332 of embedding record 330 that uniquely identifies the corresponding data object. Other data (e.g., data 334A, 334B, 334C, hereinafter collectively referred to as other data 334A-334C) may also be stored in embedding vector store with object IDs 332A-332C, respectively. The other data may include a chunk ID, a version ID, and the embedding, as illustrated in FIG. 2.

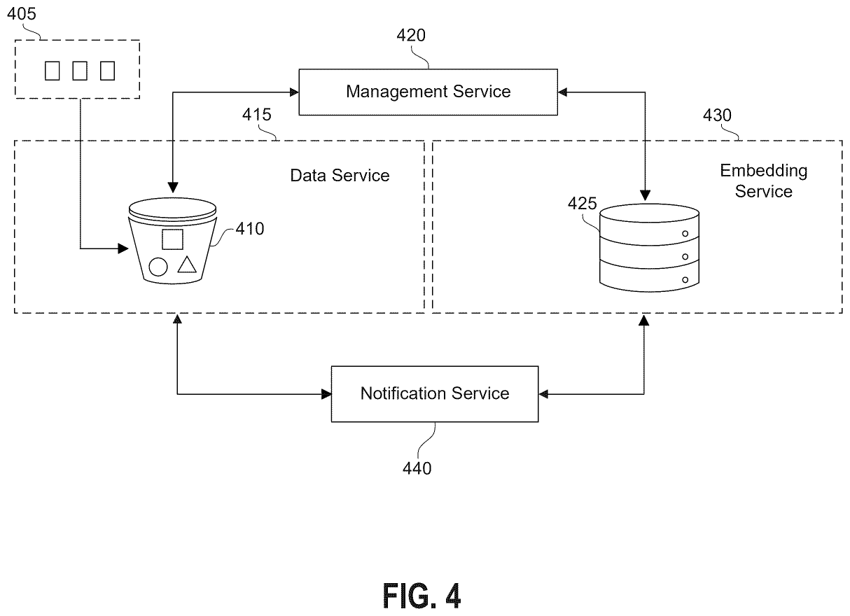

FIG. 4 illustrates a process for maintaining data accuracy between data objects and embeddings, in accordance with examples discussed herein. In this example, data service 415, management service 420, embedding service 430, and notification service 440 are illustrated with respect to the generation of embeddings.

In some examples, management service 420 may determine and distribute data management policies to other services in the system. The other services may implement the policies on relevant objects. For example, when the data objects are stored in a bucket of data objects 410 and the embeddings are stored in a collection of embeddings 425, the policies from management service 420 may be transmitted to data service 415 and embedding service 430, respectively, so that the objects maintained by data service 415 and embedding service 430 share a common policy. Data service 415 and embedding service 430 can, in turn, apply the policies to the data objects in the bucket of data objects 410 and to the embeddings in the collection of embeddings 425, respectively.

As illustrative examples, management service 420 can provide a retention policy, backup policy, or other type of policy to data service 415. Data service 415 can apply the same policies or rules to a bucket of data objects 410 as the new buckets are created. In another example, whenever the bucket is backed up, the corresponding collection of embeddings may also be backed up in accordance with the policy from management service 420. When a bucket is deleted, management service 420 may also provide a policy to embedding service 430 that instructs embedding service 430 to delete the entire collection of embeddings.

In some examples, a plurality of collections of embeddings may be stored for bucket of data objects 410 as well. In other words, one bucket of data objects 410 may correspond to a collection of embeddings 425 and any additional collections of embeddings (not shown). The collections may store a reference to the originating data object (e.g., the object ID).

Policies may also be generated for data object updates. For example, when data service 415 updates a data object or bucket of data objects 410, data service 415 may notify embedding service 430 through notification service 440 to generate a new embedding record or collection of embeddings. Notification service 440 may trigger operations within embedding service 430 to generate the new embedding (or collection) and store the embedding in the embedding vector store, along with the new UUIDs. The new UUIDs associated with the new embedding may be returned by embedding service 430 via notification service 440. The new UUIDs may also be stored as metadata in the new version of the data object.

As an illustrative example, in response to receiving unstructured data 405, data service 415 may create a data object for the unstructured data and a corresponding bucket of data objects 410. Data service 415 may automatically apply the policy to the bucket of data objects 410. In response to data service 415 updating the policy on the bucket of objects, notification service 440 may automatically transmit an electronic message to embedding service 430 about the updated policy. When the message is received, embedding service 430 may automatically apply the same policy to the collection of embeddings or any other related embeddings by embedding service 430. Using management service 420 with notification service 440, the system can create a one-to-one mapping between object versions and its embeddings. This mapping can help ensure that even if a data object is restored to its old version, the corresponding embedding can be restored without additional operations or instructions from a user.

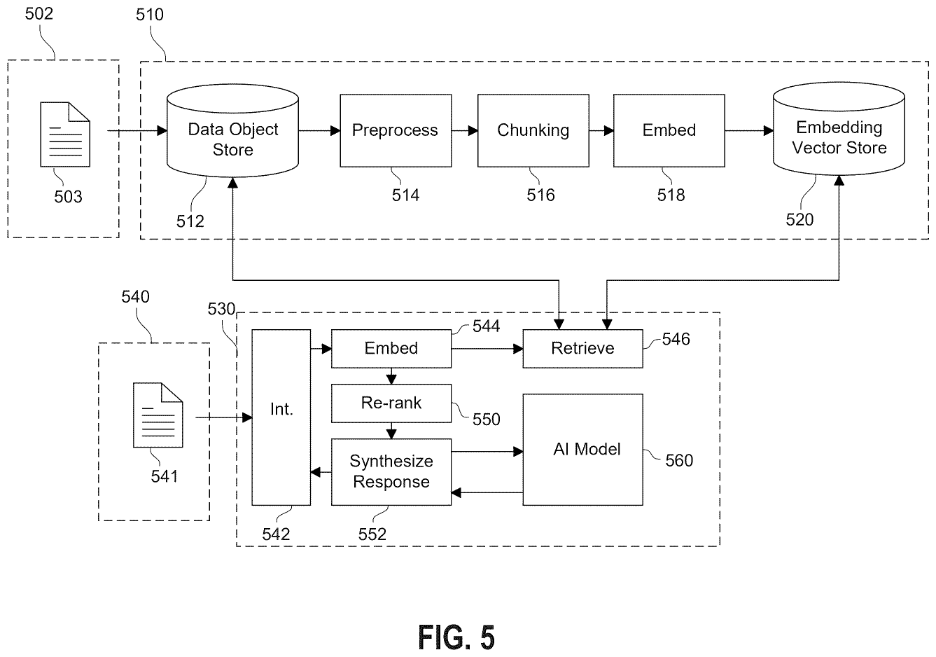

FIG. 5 illustrates a process for generating embeddings, in accordance with examples discussed herein. In this example, object storage system 510 may comprise various services discussed herein, including management service, data service, embedding service, and notification service, along with various local data stores including data objects store and embedding vector store, as described throughout the disclosure. Object storage system 510 may provide access to data object store 512 and embedding vector store 520 to a second computing device 530 that implements an AI model and generates responses to user prompts.

At block 502, a new data object 503 is received by object storage system 510. In some examples, the new data object may be generated by a distributed computing system and transmitted to object storage system 510 as a data object comprising unstructured data. In other examples, new data object 503 may be generated by object storage system 510 based on receiving unstructured data (e.g., text, images, or audio) from the distributed computing system. Either instance may be implemented without diverting from the essence of the disclosure.

The new data object 503 may be stored in data object store 512. The data object may be stored as a data object record in the data object store with a primary key or other unique identifier. When the data object is stored, an embedding service may receive a notification that the data object was created (e.g., via a notification service).

At block 514, the embedding service may preprocess the data object. For example, the preprocessing may convert the unstructured data stored with the data object to a standardized format. This may include, for example, converting a Portable Document Format (PDF) or PowerPoint® (PPT) file to a text format.

At block 516, the embedding service may chunk the unstructured data stored with the data object. In some examples, a plurality of data chunks may be created to correspond to a chunk size threshold value corresponding to the embedding model. The data chunks may be limited to the chunk size threshold value of the embedding model, causing a plurality of data chunks to be created when the unstructured data size exceeds the chunk size threshold value.

As an illustrative example, if a data size limit of unstructured data (e.g., text) is 8K and the chunk size threshold value for the embedding model is 1K, then the chunking process may partition the unstructured data into eight data chunks where the chunk data size is 1K. The 1K data chunk may be used to create individual data objects, which can ultimately create eight embeddings that correspond to the chunk size threshold value. The eight chunks may be stored as data object records in a data object store with the same primary key of the original data object.

At block 518, the embedding service may embed the data object as an embedding in embedding vector store 520 and store the primary key of the data object as the object ID for the corresponding embeddings. In other examples, a plurality of data objects corresponding with a plurality of data chunks may be embedded as a plurality of embeddings, and the embedding record may include the primary key of the data object as the object ID in the embedding record(s). When the embedding (or embeddings) is created for the data chunk, the embeddings may be stored in embedding vector store 520 as an embedding record.

At block 540, a user prompt or user query 541 (used interchangeably) from a user device may be received by a second device 530. The second device 530 may have access to object storage system 510 via a RAG agent that retrieves data from data object store 512 and embedding vector store 520.

At block 542, the user device provides the user prompt 541 to an interface associated with the second device 530.

At block 544, the second device 530 initiates an embedding process of the user prompt. For example, an embedding of the user prompt may be generated to convert the user prompt to a numerical representation. The embedding of the user prompt can encapsulate the semantic information of the user prompt in a multi-dimensional space.

In some examples, an aggregation process and/or normalization process may be implemented on the embedding of the user prompt as well. For example, the aggregation process may combine or aggregate multiple embeddings of the user prompt into a single vector representation. The second device may average the embeddings of all words/tokens or, in some examples, may combine the embeddings as a weighted combination of the embeddings. In the normalization process, the single vector representation might be normalized to help ensure that the vector has a consistent scale and distribution.

At block 546, the second device 530 may retrieve relevant data for generating a response to the user prompt (e.g., by a RAG agent). The relevancy of the data may be determined based on a similarity score between the embedding of the user prompt and the embeddings that are previously stored in embedding vector store 520. During the retrieval, the RAG agent may access the data object store 512 and embedding vector store 520 from object storage system 510 and compare the embedding of the user prompt with the embeddings of the data object. When the similarity score between two embeddings exceeds a similarity threshold, the embedding/data object may be retrieved for generating a response to the user prompt. The second device may be configured to initiate various processes, including interfacing with the user device to retrieve the user prompt and also retrieving the data object/embeddings from the data stores (via the RAG agent).

At block 550, the retrieved data may be iteratively ranked. For example, the second device 530 may rank the embeddings in relation to the relevancy to the embedding generated from the user prompt. The top embeddings may be provided to generate/synthesize a response.

At block 552, the second device 530 may synthesize a response to the user prompt through interactions with an AI model (block 560). In some examples, the AI model may be implemented as an LLM that is trained to generate responses to user prompts. The synthesized response may be provided back to the interface (block 542), which provides the response to the user device.

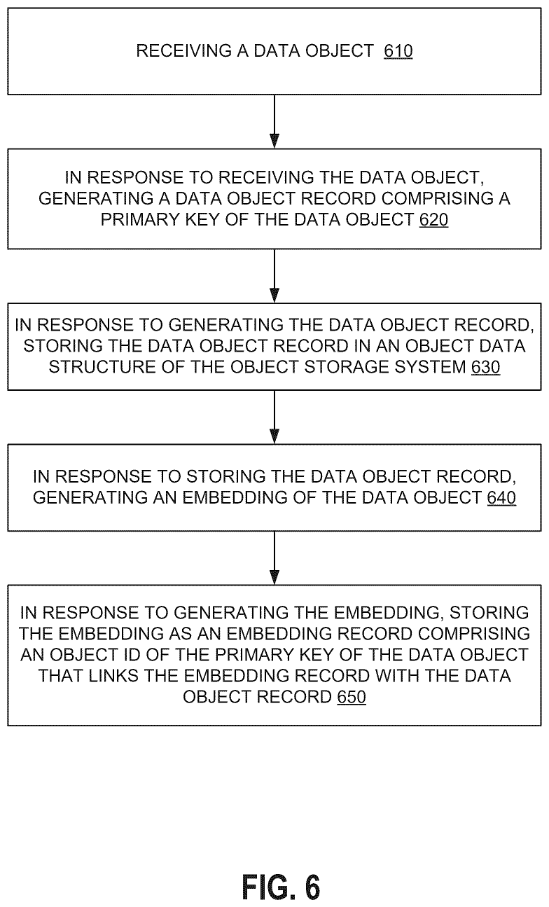

FIG. 6 is a process for generating an embedding in an object storage system, in accordance with examples discussed herein. For example, an object storage system, comprising a hardware processor and machine-readable storage medium, may perform the process corresponding to blocks 610-650 to generate the embedding.

At block 610, the process may receive a data object. The data object may be received by the object storage system. In some examples, unstructured data may be received by a data service of the object storage system.

At block 620, the process can generate a data object record in response to receiving the data object. The data object record can comprise a primary key of the data object. In some examples, a data service can generate the data object based on receiving the unstructured data. In other examples, the new data object is received by the object storage system from a user device or second system via a network.

At block 630, the process may store the data object record in an object data structure of the object storage system in response to generating the data object record. The data object record may be stored in a local data object store with a primary key associated with the data object that is also stored in a local data object store.

At block 640, the process may generate an embedding of the data object in response to storing the data object record. The embedding record may comprise an object ID of the primary key of the data object that links the embedding record with the data object record.

In some examples, the embedding record that is generated in response to entering the data object into the data object structure also comprises information associated with the embedding. The information in the embedding record may comprise, for example, a second primary key corresponding to the embedding, a chunk ID identifying an embedding of a chunk of the data object, or a version ID of the chunk of the data object.

At block 650, the process may store the embedding as an embedding record in response to generating the embedding.

In some examples, the process can identify the primary key of the data object in response to receiving an update of the data object in the object data structure. The process may synchronize the embedding with the update of the data object (e.g., by copying the updates initiated with the data object record to the embedding record). The updates may be copied to the embedding record using a notification service of the object storage system.

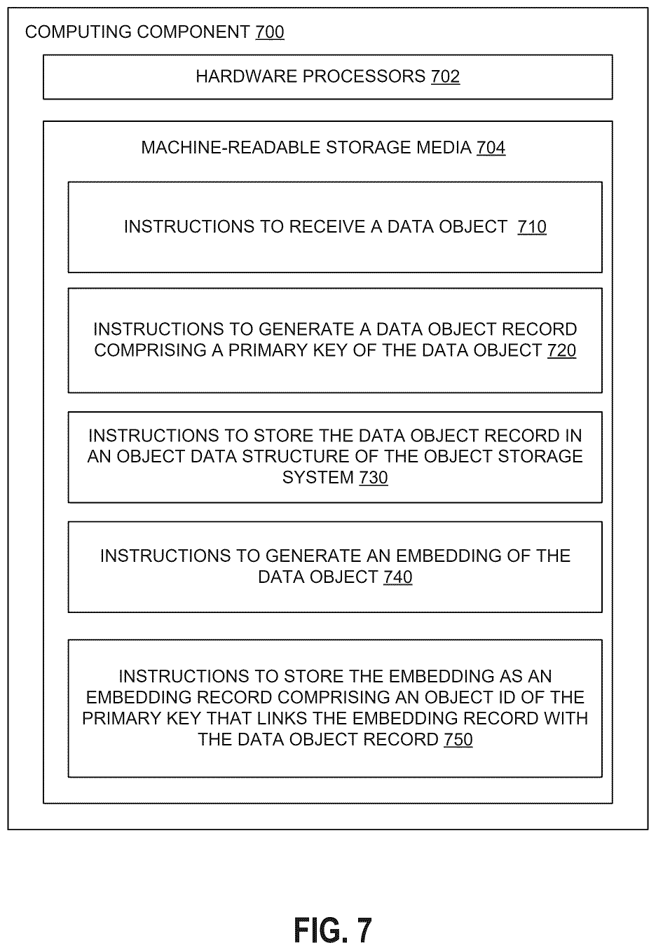

FIG. 7 is an example computing component that may be used to generate an embedding in accordance with examples discussed herein. For example, computing component 700 may be, for example, a server computer, a controller, or any other similar computing component capable of processing data. In the example implementation of FIG. 7, computing component 700 includes hardware processor 702 and machine-readable storage medium 704.

Hardware processor 702 may be one or more central processing units (CPUs), semiconductor-based microprocessors, and/or other hardware devices suitable for retrieval and execution of instructions stored in machine-readable storage medium 704. Hardware processor 702 may fetch, decode, and execute instructions, such as instructions 710-750, to control processes or operations for generating embeddings. As an alternative or in addition to retrieving and executing instructions, hardware processor 702 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 704, may be any electronic, magnetic, optical, or other physical storage device that contains or stores executable instructions. Thus, machine-readable storage medium 704 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 704 may be a non-transitory storage medium, where the term “non-transitory” does not encompass transitory propagating signals. As described in detail below, machine-readable storage medium 704 may be encoded with executable instructions, for example, instructions 710-750.

Hardware processor 702 may execute instruction 710 to receive a data object. The data object may be received by the object storage system. In some examples, unstructured data may be received by a data service of the object storage system and the data service can generate the data object based on receiving the unstructured data. In other examples, the new data object is received by the object storage system from a user device or second system via a network.

Hardware processor 702 may execute instruction 720 to generate a data object record in an object data structure of the object storage system in response to receiving the data object.

Hardware processor 702 may execute instruction 730 to store the data object record in an object data store with a primary key associated with the data object. The object data store may correspond to a local data object store that also stores the primary key in a local data object store.

Hardware processor 702 may execute instruction 740 to generate an embedding of the data object in response to storing the data object record.

Hardware processor 702 may execute instruction 750 to store the embedding as an embedding record. The embedding record may comprise an object ID of the primary key of the data object that links the embedding record with the data object record.

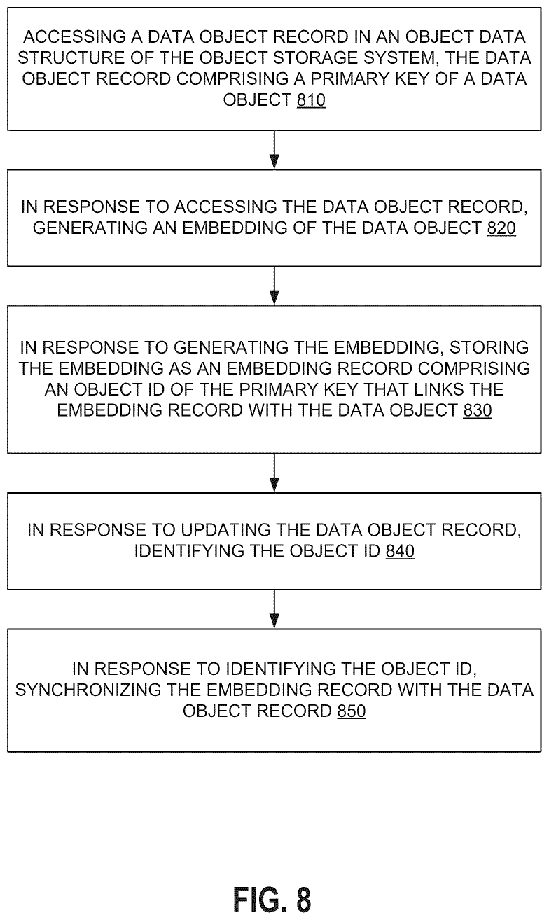

FIG. 8 is a process for synchronizing an embedding record with a data object record, in accordance with examples discussed herein. For example, an object storage system, comprising a hardware processor and machine-readable storage medium, may perform the process corresponding to blocks 810-850 to generate the embedding.

At block 810, the process may access a data object record in an object data structure. The data object record may comprise primary key of a data object. In some examples, the new data object may be received from a distributed computing system and transmitted to the object storage system as a data object comprising unstructured data. In other examples, the data object may be generated by the object storage system based on receiving unstructured data (e.g., text, images, or audio) from the distributed computing system. The data object may be stored as a data object record to allow the object data structure to access the data object.

At block 820, the process may generate an embedding of the data object in response to accessing the data object record.

At block 830, the process may store the embedding as an embedding record. The embedding record may comprise an object ID of the primary key of the data object that links the embedding record with the data object.

With the link between the data object and the embedding, the process can access both. For example, in the context of a RAG, the RAG agent may access the data object that is relevant to a user prompt. The relevancy of the data object may be determined by, for example, by comparing the embedding of the user prompt with the embedding of the data object within a threshold similarity value. In response to identifying the relevancy, the RAG can receive the data object to generate a response to the user prompt.

At block 840, the process may identify the primary key of the data object or object ID stored in the embedding record in response to updating the data object record.

At block 850, the process may synchronize the embedding record with the data object record. The synchronization may be implemented using a notification service (or other services) of the object storage system. For example, the notification service can notify an embedding service to synchronize the embedding record associated with the data object. The link between the data object and corresponding embedding(s) may be the primary key of the data object and the object ID in the embedding vector store. Using this linking, the process can automatically create and update embeddings in line with the data object's creation, update, deletion, or other data object-related actions.

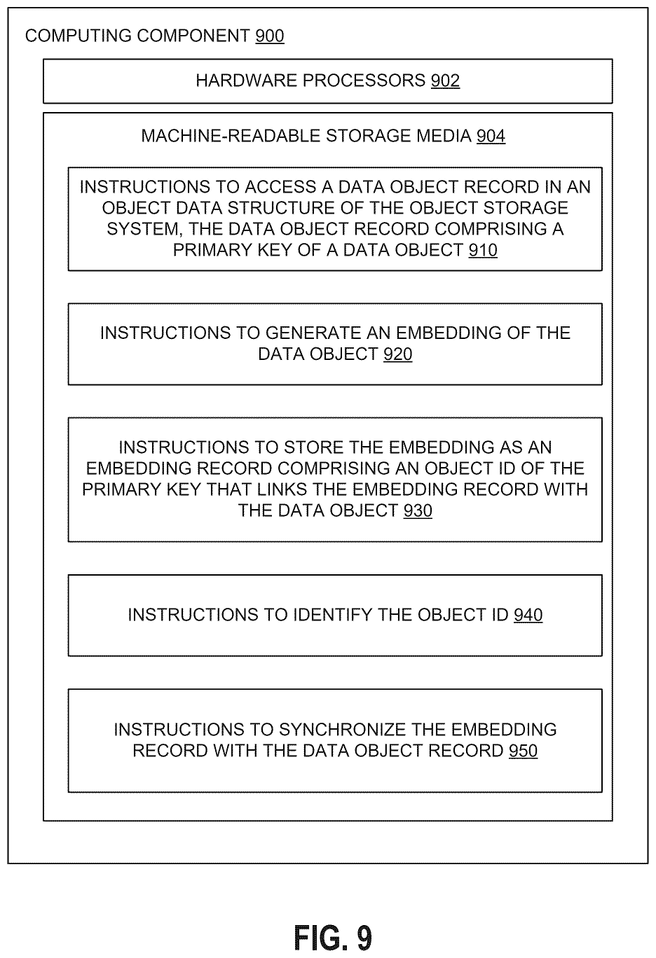

FIG. 9 is an example computing component that may be used to synchronize an embedding record with a data object record in accordance with examples discussed herein. For example, computing component 900 may be, for example, a server computer, a controller, or any other similar computing component capable of processing data. In the example implementation of FIG. 9, computing component 900 includes hardware processor 902 and machine-readable storage medium 904.

Hardware processor 902 may be one or more central processing units (CPUs), semiconductor-based microprocessors, and/or other hardware devices suitable for retrieval and execution of instructions stored in machine-readable storage medium 904. Hardware processor 902 may fetch, decode, and execute instructions, such as instructions 910-950, to control processes or operations for generating embeddings. As an alternative or in addition to retrieving and executing instructions, hardware processor 902 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 904, may be any electronic, magnetic, optical, or other physical storage device that contains or stores executable instructions. Thus, machine-readable storage medium 904 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 904 may be a non-transitory storage medium, where the term “non-transitory” does not encompass transitory propagating signals. As described in detail below, machine-readable storage medium 904 may be encoded with executable instructions, for example, instructions 910-950.

Hardware processor 902 may execute instruction 910 to access a data object record in an object data structure. The data object record may comprise primary key of a data object. In some examples, the new data object may be received from a distributed computing system and transmitted to the object storage system as a data object comprising unstructured data. In other examples, the data object may be generated by the object storage system based on receiving unstructured data (e.g., text, images, or audio) from the distributed computing system. The data object may be stored as a data object record to allow the object data structure to access the data object.

Hardware processor 902 may execute instruction 920 to generate an embedding of the data object. The generation may be initiated in response to accessing the data object record in the object data structure.

Hardware processor 902 may execute instruction 930 to store the embedding as an embedding record comprising the object ID of the primary key of the data object that links the embedding record with the data object.

Hardware processor 902 may execute instruction 940 to identify the primary key of the data object.

Hardware processor 902 may execute instruction 950 to synchronize the embedding record with the data object record in response to identifying the primary key. The synchronization may be implemented by using a notification service or other services of the object storage system. For example, the notification service can notify an embedding service to synchronize the embedding record associated with the data object. The link between the data object and corresponding embedding(s) may be the primary key of the data object and the object ID in the embedding vector store. Using this linking, the system can automatically create and update embeddings in line with the data object's creation, update, deletion, or other data object-related actions.

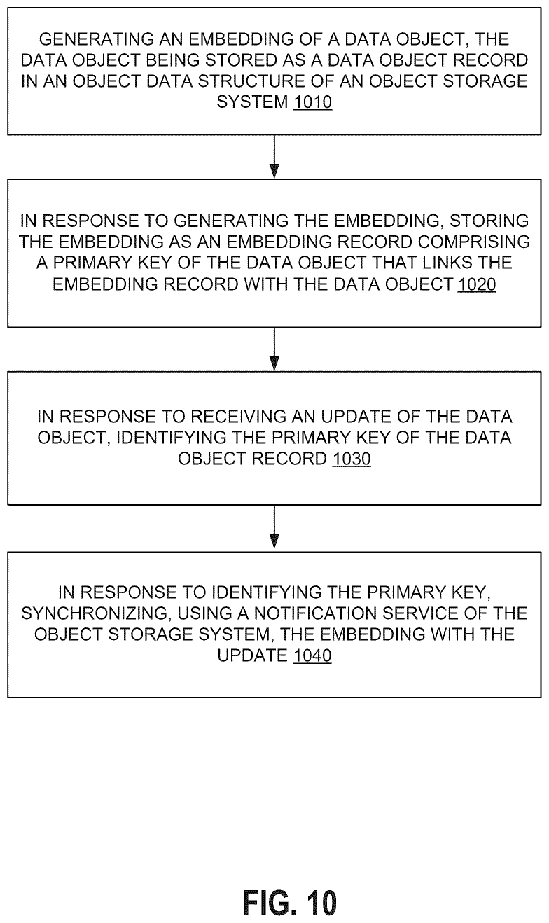

FIG. 10 is a process for accessing an embedding record, in accordance with examples discussed herein. For example, an object storage system, comprising a hardware processor and machine-readable storage medium, may perform the process corresponding to blocks 1010-1040 to generate the embedding.

At block 1010, the process may generate an embedding of a data object. The data object may be stored as a data object record in an object data structure of an object storage system.

At block 1020, the process may store the embedding in an embedding record in response to generating the embedding. The embedding record may comprise a primary key of the data object that links the embedding record with the data object.

At block 1030, the process may identify a primary key of the data object record in response to an update of the data object. The identification may be implemented by using a notification service (or other services) of the object storage system.

At block 1040, the process may synchronize the embedding with the update in response to identifying the primary key. The synchronization may also be implemented by using a notification service (or other services) of the object storage system. For example, the notification service can notify an embedding service to synchronize the embedding record associated with the data object. The link between the data object and corresponding embedding(s) may be the primary key of the data object and the object ID in the embedding vector store. Using this linking, the system can automatically create and update embeddings in line with the data object's creation, update, deletion, or other data object-related actions.

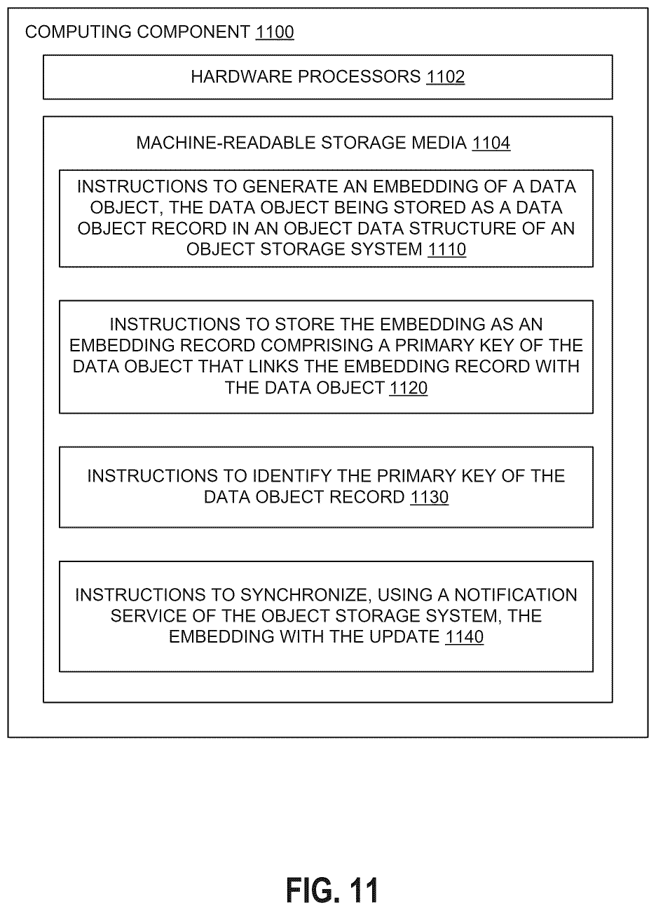

FIG. 11 illustrates a computing component that may be used to access an embedding record, in accordance with various examples of the disclosed technology. For example, computing component 1100 may be, for example, a server computer, a controller, or any other similar computing component capable of processing data. In the example implementation of FIG. 11, the computing component 1100 includes hardware processor 1102 and machine-readable storage medium 1104.

Hardware processor 1102 may be one or more central processing units (CPUs), semiconductor-based microprocessors, and/or other hardware devices suitable for retrieval and execution of instructions stored in machine-readable storage medium 1104. Hardware processor 1102 may fetch, decode, and execute instructions, such as instructions 1110-1140, to control processes or operations for generating embeddings. As an alternative or in addition to retrieving and executing instructions, hardware processor 1102 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 1104, may be any electronic, magnetic, optical, or other physical storage device that contains or stores executable instructions. Thus, machine-readable storage medium 1104 may be, for example, Random Access Memory (RAM), non-volatile RAM (NVRAM), an Electrically Erasable Programmable Read-Only Memory (EEPROM), a storage device, an optical disc, and the like. In some examples, machine-readable storage medium 1104 may be a non-transitory storage medium, where the term “non-transitory” does not encompass transitory propagating signals. As described in detail below, machine-readable storage medium 1104 may be encoded with executable instructions, for example, instructions 1110-1140.

Hardware processor 1102 may execute instruction 1110 to generate an embedding of a data object. The data object may be stored as a data object record in an object data structure of an object storage system.

Hardware processor 1102 may execute instruction 1120 to store the embedding as an embedding record comprising a primary key of the data object that links the embedding with the data object.

Hardware processor 1102 may execute instruction 1130 to identify the primary key of the data object.

Hardware processor 1102 may execute instruction 1140 to synchronize, using a notification service of the object storage system, the embedding with the update of the data object. The identification and synchronization may be initiated in response to receiving an update of the data object in the object data structure.

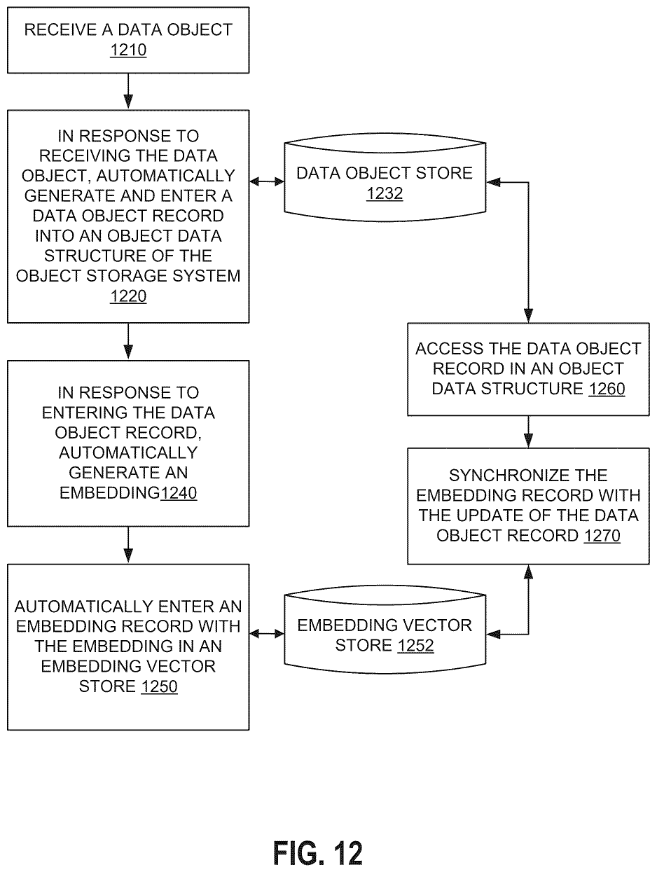

FIG. 12 is a process for generating/synchronizing a data object record with an embedding record, in accordance with examples discussed herein. For example, an object storage system, comprising a hardware processor and machine-readable storage medium, may perform the process corresponding to blocks 1210-1270 to generate or synchronize a data object record with an embedding record.

At block 1210, the process may receive a data object. The data object may be received by the object storage system. In some examples, unstructured data may be received by a data service of the object storage system and the data service can generate the data object based on receiving the unstructured data. In other examples, the new data object is received by the object storage system from a user device or second system via a network.

At block 1220, the process may automatically generate a data object record and enter the data object record in an object data structure of the object storage system in response to receiving the data object. The data object record may be entered in data object store 1232 with a primary key associated with the data object that is also stored in data object store 1232.

At block 1240, the process may automatically generate an embedding of the data object in response to entering the data object into the object data structure of the object storage system. In some examples, a data service may be configured to create the data object and an embedding service may be configured to create an embedding associated with the data object.

In some examples, when the data object is created, the embedding record may not be known to the data service. The data service may notify the embedding service of the new data object by sending the primary key of the new data object in a notification. In response, the embedding service can generate the embedding associated with the data object and return an identifier for the new embedding. The identifier may correspond to an embedding UUID or primary key of the embedding record.

In some examples, the individual data object record and the individual embedding record may be stored as groups of data. For example, in response to the data service creating the data object, a management service may be configured to create a bucket of data objects. The objects of the same bucket may be stored in data object store 1232.

At block 1250, the process may automatically enter/store the embedding record in an embedding vector store 1252. The embedding record may comprise an object ID of the primary key of the data object that links the embedding record with the data object record.

In some examples, when a bucket is created in data object store 1232 by the management service, the embedding service may be configured to create a corresponding embedding record in embedding vector store 1252. In some examples, a collection of embeddings may be created in embedding vector store 1252 to store a plurality of embeddings of the data objects associated with the bucket of data objects. The management service may also be configured to store the mapping of the bucket of data objects to the collection of embeddings. In some examples, any action taken on the bucket may also be applied to the collection in embedding vector store 1252. The collection may inherit the bucket's user access controls.

In some examples, the embeddings are stored as chunks of data. For example, the embedding service can generate the chunks of data with an embedding UUID for the embedding(s) corresponding with the chunk and insert the embedding record into embedding vector store 1252. The embedding record may comprise the embedding UUID, object ID for the corresponding data object, the embedding vector, and any other information associated with the embedding (e.g., object ID, chunk ID, and version ID). The embedding service can transmit the primary key of a newly created embedding record to the data service, which can store the primary key of the embedding record as metadata of the associated data object in data object store 1232.

At block 1260, the process may access the data object record in the object data structure, like data object store 1232. In some examples, the data service may be configured to notify the embedding service through a notification service (e.g., operated by an event notification system) regarding life cycle events of the data object. For example, the notification may comprise information about events/actions regarding the data object or its life cycle.

The notification service may be configured to transmit the notifications between the management service, the data service, and the embedding service using various data transmission protocols. For example, in response to creating/generating the data object, the data service may be configured to notify the embedding service through the notification service of the creation of the new data object. The notification may include the primary key of the data object, which may be stored as the object ID in the new embedding record. In response to updating the data object record or deleting the data object record, the data service may also be configured to notify the embedding service through the notification service along with the object ID/primary key of the data object.

At block 1270, the process may synchronize the embedding record in embedding vector store 1252 with the update of the data object record in data object store 1232. For example, the management service may be configured to apply operations executed on the bucket in data object store 1232 to the corresponding collection in embedding vector store 1252. For example, the management service may assign the same retention policy and backup policy on the bucket in data object store 1232 and the collection in embedding vector store 1252 when the bucket of data objects is created. Whenever a bucket is backed up, the corresponding collection may also be backed up. When a bucket is deleted, the management service may also delete the entire collection.

In some examples, the management service may also be configured to oversee, monitor, or otherwise manage an object life cycle on the corresponding embedding stored in embedding vector store 1252. The object life cycle can include, for example, the creation, update, and deletion of the data object and corresponding embedding(s). Various other features may be included in the object life cycle as well, including data retention, back up, and access policies.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

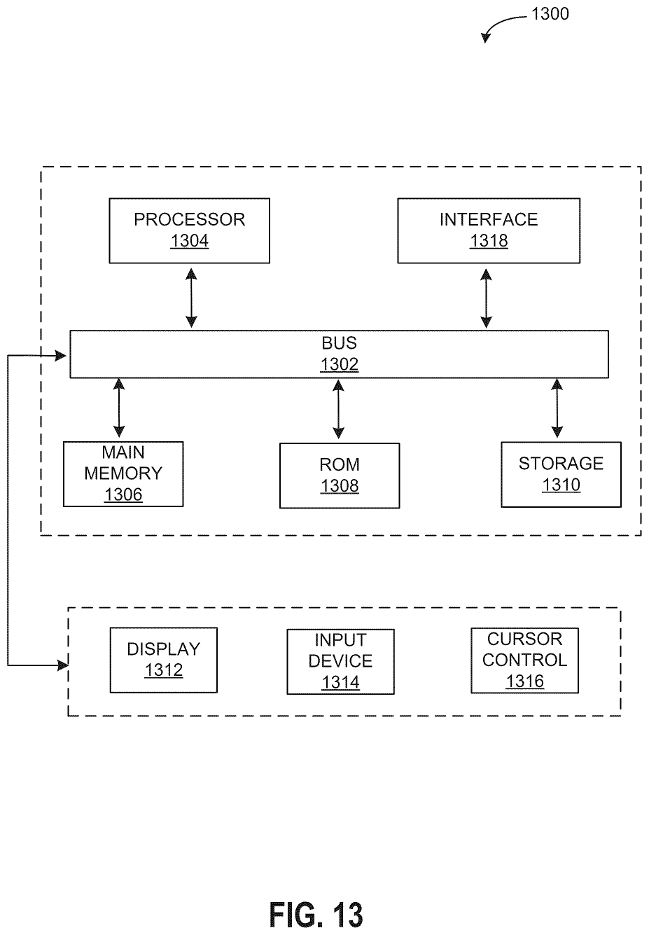

FIG. 13 depicts a block diagram of an example computer system 1300 in which various examples of the disclosed technology described herein may be implemented. Computer system 1300 includes bus 1302 or other communication mechanism for communicating information, one or more hardware processors 1304 coupled with bus 1302 for processing information. Hardware processor(s) 1304 may be, for example, one or more general purpose microprocessors.

Computer system 1300 also includes main memory 1306, such as a random access memory (RAM), cache and/or other dynamic storage devices, coupled to bus 1302 for storing information and instructions to be executed by processor 1304. Main memory 1306 also may be used for storing temporary variables or other intermediate information during execution of instructions to be executed by processor 1304. Such instructions, when stored in storage media accessible to processor 1304, render computer system 1300 into a special-purpose machine that is customized to perform the operations specified in the instructions.

Computer system 1300 further includes read only memory (ROM) 1308 or other static storage device coupled to bus 1302 for storing static information and instructions for processor 1304. Storage device 1310, such as a magnetic disk, optical disk, or USB thumb drive (Flash drive), etc., is provided and coupled to bus 1302 for storing information and instructions.

Computer system 1300 may be coupled via bus 1302 to display 1312, such as a liquid crystal display (LCD) (or touch screen), for displaying information to a computer user. The information may include, for example, a synthesized response that is generated from retrieved data objects, embeddings, updates to either the data object or the embedding, or other aspects illustrated throughout the disclosure.

Input device 1314, including alphanumeric and other keys, is coupled to bus 1302 for communicating information and command selections to processor 1304. Another type of user input device is cursor control 1316, such as a mouse, a trackball, or cursor direction keys for communicating direction information and command selections to processor 1304 and for controlling cursor movement on display 1312. In some examples, the same direction information and command selections as cursor control may be implemented via receiving touches on a touch screen without a cursor.

Computer system 1300 may include a user interface module to implement a GUI to provide to display 1312. The user interface module may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “engine,” “system,” “database,” “data store,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

Computer system 1300 may implement the techniques described herein using customized hard-wired logic, one or more ASICs or FPGAs, firmware and/or program logic which in combination with the computer system causes or programs computer system 1300 to be a special-purpose machine. According to one example of the disclosed technology, the techniques herein are performed by computer system 1300 in response to processor(s) 1304 executing one or more sequences of one or more instructions contained in main memory 1306. Such instructions may be read into main memory 1306 from another storage medium, such as storage device 1310. Execution of the sequences of instructions contained in main memory 1306 causes processor(s) 1304 to perform the process steps described herein. In alternative examples, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 1310. Volatile media includes dynamic memory, such as main memory 1306. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 1302. Transmission media can also take the form of acoustic or light waves, such as those generated during radio-wave and infra-red data communications.

Computer system 1300 also includes interface 1318 coupled to bus 1302. Interface 1318 provides a two-way data communication coupling to one or more network links that are connected to one or more local networks. For example, interface 1318 may be an integrated services digital network (ISDN) card, cable modem, satellite modem, or a modem to provide a data communication connection to a corresponding type of telephone line. As another example, interface 1318 may be a local area network (LAN) card to provide a data communication connection to a compatible LAN (or WAN component to communicate with a WAN). Wireless links may also be implemented. In any such implementation, interface 1318 sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet.” Local network and Internet both use electrical, electromagnetic or optical signals that carry digital data streams. The signals through the various networks and the signals on network link and through interface 1318, which carry the digital data to and from computer system 1300, are example forms of transmission media.

Computer system 1300 can send messages and receive data, including program code, through the network(s), network link and interface 1318. In the Internet example, a server might transmit a requested code for an application program through the Internet, the ISP, the local network and interface 1318.

The received code may be executed by processor 1304 as it is received, and/or stored in storage device 1310, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed examples. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto, such as computer system 1300.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain examples include, while other examples do not include, certain features, elements and/or steps.

Terms and phrases used in this document, and variations thereof, unless otherwise expressly stated, should be construed as open ended as opposed to limiting. Adjectives such as “conventional,” “traditional,” “normal,” “standard,” “known,” and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more,” “at least,” “but not limited to” or other like phrases in some instances shall not be read to mean that the narrower case is intended or required in instances where such broadening phrases may be absent.

What is claimed is:

1. A method comprising:
receiving, by an object storage system, a data object;
in response to receiving the data object, generating, by the object storage system, a data object record comprising a primary key of the data object;
in response to generating the data object record, storing, by the object storage system, the data object record in an object data structure of the object storage system;
in response to storing the data object record in the object data structure, generating, by the object storage system, an embedding of the data object; and
in response to generating the embedding, storing the embedding as an embedding record comprising an object identifier (ID) of the primary key of the data object that links the embedding record with the data object record.

2. The method of claim 1, wherein the embedding record further comprises:
a second primary key corresponding to the embedding; and
a chunk identifier (ID) identifying an embedding of a chunk of the data object.

3. The method of claim 2, wherein the embedding record further comprises:
a version ID of the chunk of the data object.

4. The method of claim 1, wherein the primary key is a Universally Unique Identifier (UUID) and the object ID is an object ID UUID.

5. The method of claim 1, further comprising:
in response to receiving an update to the data object record in the object data structure, identifying, by the object storage system, the primary key of the data object; and
in response to identifying the primary key, synchronizing, using a notification service of the object storage system, the embedding with the update.

6. The method of claim 1, wherein the embedding record is stored in a collection of embeddings that inherit policies from the data object record.

7. The method of claim 1, wherein the data object record is stored in a bucket of data objects that share policies across data objects in the bucket of data objects and the method further comprises:
applying, by the object storage system, the policies to the embedding record.

8. The method of claim 1, further comprising:
in response to deleting the data object, identifying, by the object storage system, the embedding record comprising the primary key of the data object; and
deleting, by the object storage system, the identified embedding record.

9. The method of claim 1, wherein a plurality of collections of embeddings link to the data object, and wherein the plurality of collections correspond to a unique policy that is shared by its embeddings.

10. The method of claim 1, wherein the data object and the embedding are accessible by a Retrieval-Augmented Generation (RAG) system.

11. The method of claim 1, wherein the primary key is a 128-bit Universally Unique Identifier (UUID) that acts as the primary key.

12. An object storage system comprising:
a memory storing instructions; and
a processor communicatively coupled to the memory and configured to execute the instructions to:
access a data object record in an object data structure of the object storage system, the data object record comprising a primary key of a data object;
in response to accessing the data object record, generate an embedding of the data object;
in response to generating the embedding, storing the embedding as an embedding record comprising an object identifier (ID) of the primary key of the data object that links the embedding record with the data object;
in response to updating the data object record, identify the object ID; and
in response to identifying the object ID, synchronize, using a notification service of the object storage system, the embedding record with the data object record that matches the object ID.

13. The object storage system of claim 12, wherein the processor is further configured to:
enter the data object into the object data structure of the object storage system.

14. The object storage system of claim 12, wherein the embedding record is stored in a collection of embeddings that inherit policies from the data object record.

15. The object storage system of claim 12, wherein the data object record is stored in a bucket of data objects that share policies across data objects in the bucket of data objects and the processor is further configured to:
apply the policies to the embedding record.

16. The object storage system of claim 12, wherein the processor is further configured to:
in response to deleting the data object, identify the embedding record comprising the object ID of the primary key of the data object; and
delete the identified embedding record.

17. The object storage system of claim 12, wherein a plurality of collections of embeddings link to the data object, and wherein the plurality of collections correspond to a unique policy that is shared by its embeddings.

18. The object storage system of claim 12, wherein the data object and the embedding are accessible by a Retrieval-Augmented Generation (RAG) system.

19. A non-transitory computer-readable storage medium storing a plurality of instructions executable by a processor, the plurality of instructions when executed by the processor cause the processor to:
generate an embedding of a data object, the data object being stored as a data object record in an object data structure of an object storage system;
in response to generating the embedding, store the embedding as an embedding record comprising a primary key of the data object record that links the embedding with the data object;
in response to receiving an update of the data object, identify the primary key of the data object record; and
in response to identifying the primary key, synchronize, using a notification service of the object storage system, the embedding with the update.

20. The non-transitory computer-readable storage medium of claim 19, wherein the instructions further cause the processor to:
apply a policy of the data object record to the embedding record.
